(19) United States
(12) Patent Application Publication
(10) Pub. No.: US 2026/0121458 A1
(43) Pub. Date: Apr. 30, 2026

(54) WIRELESS POWER TRANSMISSION DEVICE AND MANUFACTURING METHOD THEREOF

(71) Applicant: WARP SOLUTION INC., Sampung-ro Gyeongsan-si Gyeongsangbuk-do (KR)

(72) Inventor: Kyunghak LEE, Sampung-ro Gyeongsan-si Gyeongsangbuk-do (KR)

(21) Appl. No.: 19/286,298

(22) Filed: Jul. 31, 2025

(30) Foreign Application Priority Data
Oct. 4, 2024 (KR) 10-2024-0134987

(51) Int. Cl. H02J 50/70; H02J 50/23; H02J 50/40

(52) U.S. Cl. CPC H02J 50/70; H02J 50/23; H02J 50/40

(57) ABSTRACT

Disclosed are a wireless power transmitter and a wireless power transmission method of the same that may consider interference between a plurality of wireless power transmitters in a multi-charging environment.

### CROSS-REFERENCE TO RELATED APPLICATION(S)

This application claims the priority benefit of Korean Patent Application No. 10-2024-0134987, filed on Oct. 4, 2024, in the Korean Intellectual Property Office, the disclosure of which is incorporated herein by reference.

### BACKGROUND

### 1. Field of the Invention

The following example embodiments relate to radio frequency (RF) wireless power transmission technology and, more particularly, to a wireless power transmission device and an operating method of the same.

### 2. Description of the Related Art

With the recent spread of portable terminals and advancement of wireless charging technology, wireless charging systems for portable terminals are also being actively developed.

Wireless charging technology refers to technology that charges a portable terminal according to a power signal transmitted from a wireless power transmission device based on one of a magnetic resonance scheme, a magnetic induction scheme, and a radio frequency (RF), and, in a wireless charging system, the portable terminal is embedded with a wireless power reception device and receives a power signal from a wireless power transmission device and uses the same for charging.

Such existing wireless charging technology simply controls frequency of a power signal transmitted from an RF wireless power transmitter in consideration of only an Rx frequency of an RF wireless power receiver and does not consider interference between a plurality of RF wireless power transmitters in a multi-charging environment in which a plurality of RF wireless power transmitters to transmit a power signal are present.

Accordingly, there is a need to propose technology that considers interference between a plurality of RF wireless power transmitters in a multi-charging environment.

### SUMMARY

Example embodiments propose a radio frequency (RF) wireless power transmitter and an RF wireless power transmission method of the same that may minimize interference between a plurality of RF wireless power transmitters and may improve power transfer efficiency in a multi-charging environment.

However, technical subjects to be solved by the present invention are not limited to the subjects described above and may be expanded in various ways without departing from the technical spirit and scope of the present.

According to an embodiment, there is provided a wireless power transmitter included in a wireless charging system, the wireless power transmitter including a transmitter configured to transmit a power signal to at least one wireless power receiver; a detector configured to acquire information on an interference signal from another wireless power transmitter; and a controller configured to control at least one parameter of the power signal based on information of the interference signal.

According to an aspect, the controller may be configured to control the at least one parameter of the power signal transmitted from the wireless power transmitter to minimize interference by the interference signal that is a power signal transmitted from the other wireless power transmitter.

According to another aspect, the controller may be configured to control at least one parameter among a frequency, a polarization direction, and a phase of the power signal transmitted from the wireless power transmitter based on information on a frequency, a polarization direction, and a phase of the interference signal.

According to still another aspect, the controller may be configured to control the frequency of the power signal transmitted from the wireless power transmitter to a band different from the frequency of the interference signal, to control the polarization direction of the power signal transmitted from the wireless power transmitter to a polarization direction orthogonal to the polarization direction of the interference signal, or to control the phase of the power signal transmitted from the wireless power transmitter to be orthogonal or identical to the phase of the interference signal.

According to still another aspect, the controller may be configured to control at least one parameter among a duty ratio, a beam sharpness, and a beam shape of the power signal transmitted from the wireless power transmitter based on information on a duty ratio, a beam sharpness, and a beam shape of the interference signal.

According to still another aspect, the controller may be configured to control the at least one parameter of the power signal further based on reception characteristic information of the at least one wireless power receiver.

According to still another aspect, the controller may be configured to predict future interference that occurs due to the interference signal using an interference prediction model pretrained based on a previous interference pattern and control results and to preemptively control the at least one parameter of the power signal based on the predicted interference.

According to still another aspect, the controller may be configured to individually control the at least one parameter of the power signal according to a plurality of wireless power receivers based on location information and reception characteristic information of each of the plurality of wireless power receivers, in an environment in which the plurality of wireless power receivers are present.

According to still another aspect, the controller may be configured to dynamically adjust a power level of the power signal based on information of the interference signal and a charging state of the at least one wireless power receiver.

According to still another aspect, the wireless power transmitter may be designed to transmit the power signal to an authenticated wireless power receiver, and configured to transmit the power signal by including encrypted authentication information in the power signal.

According to still another aspect, the wireless power transmitter may include a digital signal processor configured to control the at least one parameter of the power signal; and a phase array antenna configured to be controlled by the digital signal processor.

According to an example embodiment, there is provided a wireless power transmission method of a wireless power transmitter included in a wireless charging system, the wireless power transmission method including acquiring information on an interference signal from another wireless power transmitter; controlling at least one parameter of the power signal based on information of the interference signal; and transmitting the parameter-controlled power signal to at least one wireless power receiver.

According to an aspect, the controlling may include controlling the at least one parameter of the power signal transmitted from the wireless power transmitter to minimize interference by the interference signal that is a power signal transmitted from the other wireless power transmitter.

According to another aspect, the controlling may include controlling the at least one parameter among a frequency, a polarization direction, and a phase of the power signal transmitted from the wireless power transmitter based on information on a frequency, a polarization direction, and a phase of the interference signal.

According to still another aspect, the controlling may include one of controlling the frequency of the power signal transmitted from the wireless power transmitter to a band different from the frequency of the interference signal; controlling the polarization direction of the power signal transmitted from the wireless power transmitter to be orthogonal to the polarization direction of the interference signal; and controlling the phase of the power signal transmitted from the wireless power transmitter to be orthogonal or identical to the phase of the interference signal.

According to still another aspect, the controlling may include controlling at least one parameter among a duty ratio, a beam sharpness, and a beam shape of the power signal transmitted from the wireless power transmitter based on information on a duty ratio, a beam sharpness, and a beam shape of the interference signal.

According to still another aspect, the controlling may include controlling the at least one parameter of the power signal further based on reception characteristic information of the at least one wireless power receiver.

According to still another aspect, the acquiring may include one of receiving information of the interference signal from the other wireless power transmitter; and receiving the interference signal from the other wireless power transmitter and then analyzing the interference signal and extracting the information of the interference signal.

According to some example embodiments, there may be proposed an RF wireless power transmitter and an RF wireless power transmission method of the same that may minimize interference between a plurality of RF wireless power transmitters and may improve power transfer efficiency in a multi-charging environment.

However, effects of the present invention are not limited to the effects described above and may be expanded in various ways without departing from the technical spirit and scope of the present.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a wireless charging environment according to an example embodiment;

FIG. 2 illustrates a radio frequency (RF) wireless power transmitter according to an example embodiment;

FIG. 3 illustrates a frequency spectrum of a power signal transmitted from an RF wireless power transmitter according to an example embodiment;

FIGS. 4 and 5 illustrate an example of describing the effect of an RF wireless power transmitter according to an example embodiment;

FIG. 6 is a flowchart illustrating an RF wireless power transmission method of an RF wireless power transmitter according to an example embodiment; and

FIG. 7 illustrates an example for describing a case in which an RF wireless power transmission method according to an example embodiment is performed during power transmission according to an example embodiment.

### DETAILED DESCRIPTION

Hereinafter, example embodiments will be described in detail with reference to the accompanying drawings. However, the present invention is not limited to or restricted by the example embodiments. Also, like reference numerals refer to like elements presented in each drawing.

Also, terms (terminology) used herein refer to terms used to appropriately explain example embodiments and may vary depending on the intent of a viewer or an operator or customs of the field to which the present invention pertains. Therefore, the terms need to be defined based on the contents throughout the present specification. For example, in this specification, the singular form also includes the plural form unless the context particularly states otherwise. Also, the terms “comprises” and “comprising,” when used in this specification, specify the presence of stated components, steps, operations, and/or elements, but do not preclude the presence or addition of one or more other components, steps, operations, and/or elements. Also, although terms, such as first and second, are used herein to describe various areas, directions, and shapes, the areas, the directions, and the shapes should not be limited by such terms. These terms are simply used to distinguish one area, direction, or shape from another area, direction, or shape. Therefore, a portion referred to as a first portion in one example embodiment may also be referred to as a second portion in another example embodiment.

It should be understood that, although various example embodiments may differ from one another, they are not necessarily mutually exclusive. For example, specific shapes, structures, and features described herein may be implemented in another example embodiment without departing from the technical spirit and scope of the invention in relation to one example embodiment. Also, it should be understood that a location, arrangement, or configuration of an individual component in each of the presented example embodiment may be changed without departing from the technical spirit and scope of the invention.

Hereinafter, a wireless power transmitter and a wireless power transmission method of the same that may consider interference between a plurality of wireless power transmitters in a multi-charging environment according to example embodiments will be described with reference to the accompanying drawings. Also, the following wireless power transmitters and wireless power transmission method are described on the assumption that a power signal is transmitted in a radio frequency (RF) form, but are not limited thereto or restricted thereby.

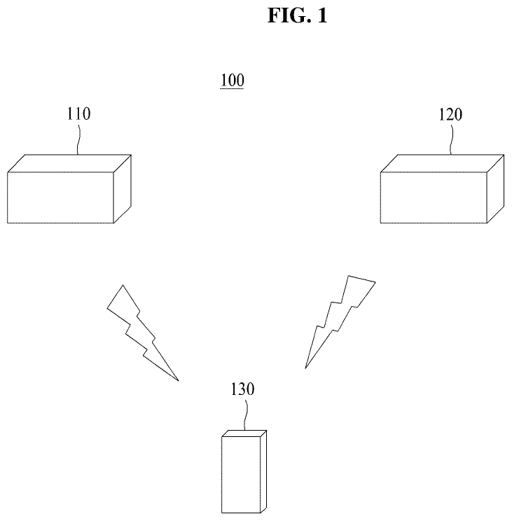

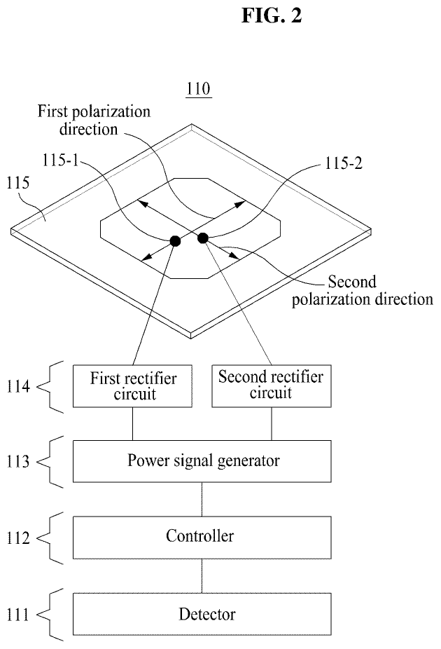

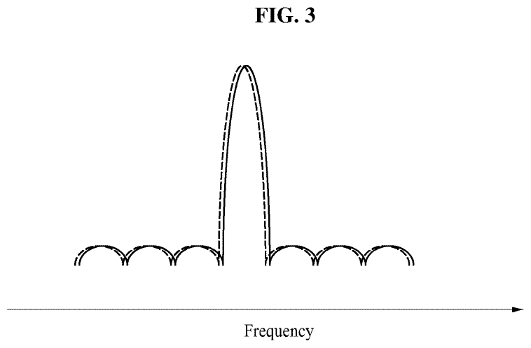

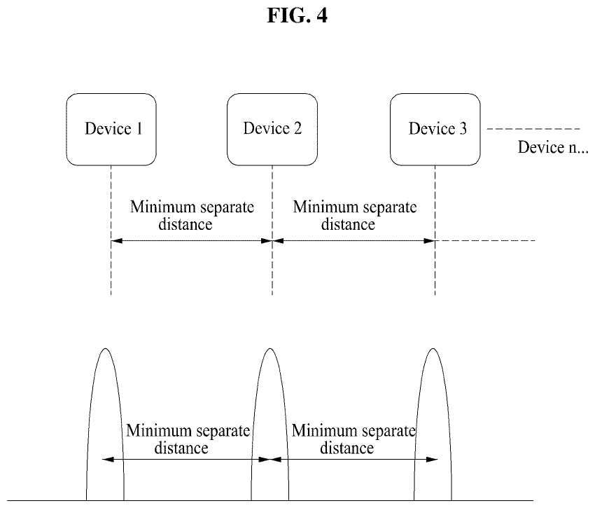

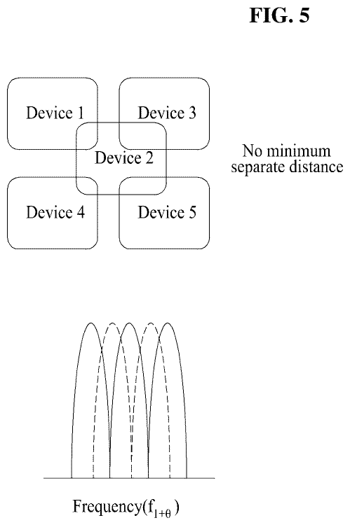

FIG. 1 illustrates a wireless charging environment according to an example embodiment, FIG. 2 illustrates an RF wireless power transmitter according to an example embodiment, FIG. 3 illustrates a frequency spectrum of a power signal transmitted from an RF wireless power transmitter according to an example embodiment, and FIGS. 4 and 5 illustrate an example of describing the effect of an RF wireless power transmitter according to an example embodiment.

Referring to the drawings, a wireless charging environment 100 refers to a multi-charging environment in which each of a plurality of RF wireless power transmitters 110 and 120 transmits a power signal to at least one RF wireless power receiver 130.

Therefore, the RF wireless power transmitter described below refers to one of the plurality of RF wireless power transmitters 110 and 120 that operate in the multi-charging environment 100. For convenience of description, the following description is made based on a case in which the wireless power transmitter is one, the RF wireless power transmitter 110, of the plurality of RF wireless power transmitters 110 and 120.

The RF wireless power transmitter 110 may be implemented to have a wireless charging function of transmitting a power signal using an RF scheme. The power signal may be implemented in a form of a pulse or a continuous wave (CW).

To this end, as shown in FIG. 2, the RF wireless power transmitter 110 may include a detector 111, a controller 112, a power signal generator 113, at least one rectifier circuit 114, and at least one transmit antenna 115. However, the RF wireless power transmitter 110 is not limited to or restricted by a structure described below, and may be implemented to be capable of adaptively adjusting a frequency, a polarization direction, and a phase of a power signal to transmit.

The detector 111 is a component configured to acquire and detect information on an interference signal (hereinafter, the interference signal represents a power signal transmitted from another RF wireless power transmitter 120 other than the RF wireless power transmitter 110), and may directly or indirectly receive information itself on the interference signal from the other RF wireless power transmitter 120 or may receive the interference signal from the other RF wireless power transmitter 120 and then, acquire and detect information of the interference signal by analyzing the interference signal and by extracting information of the interference signal.

Here, information on the interference signal may include information on a frequency, a polarization direction, and a phase of the interference signal. Therefore, the detector 111 may directly or indirectly receive information on the frequency, the polarization direction, and the phase of the interference signal from the RF wireless power transmitter 120 or may receive the interference signal and then, acquire and detect information of the interference signal by analyzing the interference signal and by extracting information on the frequency, the polarization direction, and the phase of the interference signal.

The detector 111 may perform an interference signal detection operation by distinguishing a case of detecting the other RF wireless power transmitter 120 of which information is acquired in advance and a case of detecting newly introduced RF wireless power transmitter of which information is not acquired in advance.

For example, when information on the interference signal that is the power signal transmitted from the other RF wireless power transmitter 120 is acquired in advance, the detector 111 does not need to directly or indirectly receive or analyze and extract information on the interference signal of the other RF wireless power transmitter 120. Therefore, when acquiring in advance information on the interference signal that is the power signal transmitted from the other RF wireless power transmitter 120, the detector 111 may acquire information on the interference signal of the other RF wireless power transmitter 120 by storing and simply loading the information.

As another example, for the newly introduced RF wireless power transmitter of which information is not acquired in advance, the detector 111 may acquire information on the interference signal of the newly introduced RF wireless power transmitter by directly or indirectly receiving or by analyzing and extracting information on the interference signal that is a power signal transmitted from the newly introduced RF wireless power transmitter.

As another example, when the newly introduced RF wireless power transmitter of which information is not acquired in advance is a transmitter of the same type and model as the other RF wireless power transmitter 120 of which information is acquired in advance, the detector 111 may not store information on the interference signal of the newly introduced RF wireless power transmitter, but may detect that the newly introduced RF wireless power transmitter is a transmitter of the same type and model as the other RF wireless power transmitter 120 of which information is acquired in advance, may predict that the interference signal of the newly introduced RF wireless power transmitter is identical or similar to the interference signal of the other RF wireless power transmitter 120 of which information is acquired in advance, and may load and acquire the stored information on the interference signal of the other RF wireless power transmitter 120.

The controller 112 may control at least one parameter of the power signal based on information of the interference signal. More specifically, the controller 112 may control at least one parameter among the frequency, the polarization direction, and the phase of the power signal transmitted from the RF wireless power transmitter 110 based on information on the frequency, the polarization direction, and the phase of the interference signal.

Here, that the controller 112 controls at least one parameter related to the power signal based on information of the interference signal indicates adjusting and changing at least one parameter related to the power signal transmitted from the RF wireless power transmitter 110 to minimize interference by the interference signal.

For example, the controller 112 may minimize the interference with the power signal caused by the interference signal by controlling the frequency of the power signal transmitted from the RF wireless power transmitter 110 to a band different from the frequency of the interference signal. Here, changing and adjusting and controlling the frequency represents frequency hopping.

As another example, the controller 112 may minimize the interference with the power signal caused by the interference signal by controlling the polarization direction of the power signal transmitted from the RF wireless power transmitter 110 to be orthogonal to the polarization direction of the interference signal.

As another example, the controller 112 may minimize the interference with the power signal caused by the interference signal by controlling the phase of the power signal transmitted from the RF wireless power transmitter 110 to be orthogonal or identical to the phase of the interference signal.

In controlling the frequency, the polarization direction, or the phase of the power signal, the controller 112 may sequentially control the frequency, the polarization direction, and the phase in order of the frequency, the polarization direction, and the phase. For example, if the interference signal is causing or expected to cause interference with the power signal transmitted from the RF wireless power transmitter 110 based on information of the interference signal, the controller 112 may change and adjust the frequency of the power signal and then transmit the same to at least one RF wireless power receiver 130. If the interference signal is still causing or expected to cause interference with the power signal despite controlling the frequency of the power signal, the controller 112 may change and adjust first the frequency and then the polarization direction and the phase of the power signal and then transmit the same to the at least one RF wireless power receiver 130.

However, without being limited thereto or restricted thereby, the RF wireless power transmitter 110 may control at least one parameter among the frequency, the polarization direction, and the phase of the power signal, regardless of the control order of the described parameters.

Also, the controller 112 may control at least one parameter among a duty ratio, a beam sharpness, and a beam shape of the power signal transmitted from the RF wireless power transmitter 110 based on information on a duty ratio, a beam sharpness, and a beam shape of the interference signal.

Similar to a case of controlling at least one parameter among the frequency, the polarization direction, and the phase, the controller 112 may adjust and change at least one parameter among the duty ratio, the beam sharpness, and the beam shape of the power signal transmitted from the RF wireless power transmitter 110 to minimize interference by the interference signal.

For example, the controller 112 may control the power signal to have the duty ratio, the beam sharpness, and the beam shape different from the duty ratio, the beam sharpness, and the beam shape of the interference signal.

Although it is described that the controller 112 controls at least one parameter among the frequency, the polarization direction, the phase, the duty ratio, the beam sharpness, and the beam shape of the power signal in consideration of the interference signal that is the power signal transmitted from another RF wireless power transmitter 120 other than the RF wireless power transmitter 110 in the multi-charging environment 100, the controller 112 may control the at least one parameter among the frequency, the polarization direction, the phase, the duty ratio, the beam sharpness, and the beam shape of the power signal by further considering reception characteristic information of the at least one RF wireless power receiver 130 such that the power reception performance of the at least one RF wireless power receiver 130 may be ensured, without being limited thereto or restricted thereby.

For example, the controller 112 may control the at least one parameter among the frequency, the polarization direction, the phase, the duty ratio, the beam sharpness, and the beam shape of the power signal transmitted from the RF wireless power transmitter 110 further based on information on an Rx frequency, an Rx polarization direction, an Rx phase, an Rx duty ratio, an Rx beam sharpness, and an Rx beam shape of the at least one RF wireless power receiver 130.

That is, the controller 112 may control at least one parameter among the frequency, the polarization direction, the phase, the duty ratio, the beam sharpness, and the beam shape of the power signal transmitted from the RF wireless power transmitter 110 by simultaneously considering an interference frequency, an interference polarization direction, an interference phase, an interference duty ratio, an interference beam sharpness, and an interference beam shape of the interference signal and the Rx frequency, the Rx polarization direction, the Rx phase, the Rx duty ratio, the Rx beam sharpness, and the Rx beam shape of the at least one RF wireless power receiver 130 to minimize interference by the interference signal and, at the same time, to maximize the power reception efficiency in the at least one RF wireless power receiver 130.

Also, the controller 112 may dynamically adjust a power level of the power signal based on information of the interference signal and a charging state of the at least one RF wireless power receiver 130.

Also, the controller 112 may predict future interference that occurs due to the interference signal using an interference prediction model pretrained based on a previous interference pattern and control results and may preemptively control the at least one parameter of the power signal based on the predicted interference.

Also, the controller 112 may individually control the at least one parameter of the power signal according to a plurality of RF wireless power receivers based on location information and reception characteristic information of each of the plurality of RF wireless power receivers, in an environment in which the plurality of RF wireless power receivers are present.

The power signal-related parameter control of the controller 112 described above may be performed before the RF wireless power transmitter 110 operates, or may be performed while the RF wireless power transmitter 110 is operating.

For example, the controller 112 may perform the aforementioned power signal-related parameter control before transmitting the power signal and then may start to transmit the parameter-controlled power signal.

As another example, the controller 112 may perform the forementioned power signal-related parameter control while transmitting the power signal, thereby converting the power signal being transmitted to the parameter-controlled power signal in real time and continuing transmission.

Although it is described that controlling at least one parameter among the frequency, the polarization direction, the phase, the duty ratio, the beam sharpness, and the beam shape of the power signal described above individually controls at least one parameter among the frequency, the polarization direction, the phase, the duty ratio, the beam sharpness, and the beam shape of the power signal, it is not limited thereto or restricted thereby.

For example, the aforementioned controlling at least one parameter among the frequency, the polarization direction, the phase, the duty ratio, the beam sharpness, and the beam shape of the power signal may be performed by generating a plurality of sets of at least one parameter among the frequency, the polarization direction, the phase, the duty ratio, the beam sharpness, and the beam shape of the power signal in advance and by selecting and applying at least one set from among the plurality of sets when the interference signal is detected.

The power signal generator 113 refers to a component that generates the power signal, and may be configured to generate the power signal of which frequency, phase, duty ratio, beam sharpness, and beam shape are adjusted under control of the controller 112.

The at least one rectifier circuit 114 refers to a component that transmits a power signal with a frequency of a specific band from the power signal generator 113 to the at least one transmit antenna 115, and may be omitted depending on an implementation example.

The at least one transmit antenna 115 includes a plurality of feed points 115-1 and 115-2, and may be configured to control the polarization direction of the power signal by selectively using one of the plurality of feed points 115-1 and 115-2 under control of the controller 112.

For example, since two feed points 115-1 and 115-2 of which polarization directions are orthogonal to each other are provided, the at least one transmit antenna 115 may determine one of the orthogonal polarization directions and may transmit the power signal along the polarization direction.

The at least one rectifier circuit 114 and the at least one transmit antenna 115 described above may be provided as a single component called a transmitter.

The RF wireless power transmitter 110 as above transmits the power signal of which parameter is controlled in consideration of the interference signal of the other RF wireless power transmitter 120, so may achieve the technical effect of transmitting the power signal while excluding and preventing interference from the other RF wireless power transmitter 120 as shown in the frequency spectrum of FIG. 3.

For example, in the wireless charging environment 100 including the existing RF wireless power transmitters (Devices 1, 2, and 3), a condition that a physical distance between the respective RF wireless power transmitters (Devices 1, 2, and 3) needs to be separate as shown in an upper portion of FIG. 4 and a condition that frequency bands of power signals transmitted from the respective RF wireless power transmitters (Devices 1, 2, and 3) need to be separated as shown in a lower portion of FIG. 4 need to be satisfied for smooth power signal transmission of each of the RF wireless power transmitters (Devices 1, 2, and 3).

On the other hand, in the wireless charging environment 100 including RF wireless power transmitters (Devices 1, 2, 3, 4, and 5) to which the aforementioned technology for controlling the power signal according to the interference signal is applied, although physical distances between the respective RF wireless power transmitters (Devices 1, 2, 3, 4, and 5) overlap without being separated as shown in an upper portion of FIG. 5, power signal transmission may be smoothly performed, and although frequency bands of power signals transmitted from the respective RF wireless power transmitters (Devices 1, 2, 3, 4, and 5) overlap as shown in a lower portion of FIG. 5, power signal transmission may be smoothly performed.

Therefore, in the wireless charging environment 100 to which the technology for controlling the power signal according to the interference signal of the RF wireless power transmitter 110 is applied according to an example embodiment, the effect of achieving the maximum power transmission efficiency with lower output power may be achieved.

The RF wireless power transmitter 110 according to an example embodiment is not limited to or restricted by the aforementioned structure, and may be implemented to include a digital signal processor (DSP) configured to control at least one parameter of the power signal and a phase array antenna configured to be controlled by the digital signal processor.

Also, the RF wireless power transmitter 110 may be designed to transmit the power signal only to an authenticated RF wireless power receiver and may be implemented to transmit the power signal by including encrypted authentication information in the power signal. For example, the RF wireless power transmitter 110 allows the authenticated RF wireless power receiver to hold a key that allows the authenticated RF wireless power receiver to receive and store the power signal transmitted from the RF wireless power transmitter 110, thereby preventing an unauthenticated RF wireless power receiver from receiving the power signal due to not holding the key and allowing only the authenticated RF wireless power receiver to decrypt the authentication information using the holding key and then to receive and store the power signal.

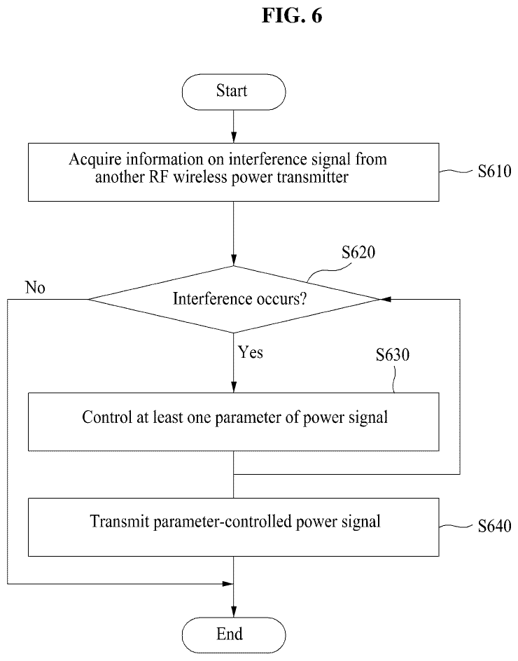

FIG. 6 is a flowchart illustrating an RF wireless power transmission method of an RF wireless power transmitter according to an example embodiment. The RF wireless power transmission method described below is assumed to be performed by the RF wireless power transmitter 110 described with reference to FIGS. 1 to 5.

In operation S610, the detector 111 may acquire information on an interference signal from another RF wireless power transmitter 120.

In more detail, in operation S610, the detector 11 may directly or indirectly receive information itself on the interference signal from the other RF wireless power transmitter 120 or may receive the interference signal from the other RF wireless power transmitter 120 and then, acquire and detect information of the interference signal by analyzing the interference signal and by extracting information of the interference signal.

Here, information on the interference signal may include information on a frequency, a polarization direction, and a phase of the interference signal. Therefore, the detector 111 may directly or indirectly receive information on the frequency, the polarization direction, and the phase of the interference signal from the RF wireless power transmitter 120 or may receive the interference signal and then, acquire and detect information of the interference signal by analyzing the interference signal and by extracting information on the frequency, the polarization direction, and the phase of the interference signal.

Also, information on the interference signal may include information on a duty ratio, a beam sharpness, and a beam shape of the interference signal. Therefore, the detector 111 may directly or indirectly receive information on the duty ratio, the beam sharpness, and the beam shape of the interference signal from the RF wireless power transmitter 120, or may receive the interference signal and then acquire and detect information of the interference signal by analyzing the interference signal and by extracting information on the duty ratio, the beam sharpness, and the beam shape of the interference signal.

In operation S620, the controller 112 may determine or predict whether interference occurs or will occur in power signal transmission in the RF wireless power transmitter 110 based on information of the interference signal.

If interference is analyzed to occur as a result of determination or prediction, the controller 112 may control at least one parameter of the power signal in operation S630.

In detail, in operation S630, the controller 112 may control at least one parameter of the power signal transmitted from the RF wireless power transmitter 110 to minimize interference by the interference signal.

As described above, since information of the interference signal includes information on the frequency, the polarization direction, and the phase of the interference signal, and the at least one parameter of the power signal includes the frequency, the polarization direction, and the phase of the power signal, the controller 112 may control at least one parameter among the frequency, the polarization direction, and the phase of the power signal transmitted from the RF wireless power transmitter 110 to minimize interference by the interference signal based on information on the frequency, the polarization direction, and the phase of the interference signal in operation S630.

For example, in operation S630, the controller 112 may control the frequency of the power signal transmitted from the RF wireless power transmitter 110 to a band different from the frequency of the interference signal, to minimize the interference with the power signal caused by the interference signal. Here, changing and adjusting and controlling the frequency represents frequency hopping.

As another example, in operation S630, the controller 112 may control the polarization direction of the power signal transmitted from the RF wireless power transmitter 110 to be orthogonal to the polarization direction of the interference signal to minimize the interference with the power signal caused by the interference signal.

As another example, in operation S630, the controller 112 may control the phase of the power signal transmitted from the RF wireless power transmitter 110 to be orthogonal or identical to the phase of the interference signal to minimize the interference with the power signal caused by the interference signal.

Here, when controlling the frequency, the polarization direction, and the phase of the power signal in operation S630, the controller 112 may sequentially control the frequency, the polarization direction, and the phase in order of the frequency, the polarization direction, and the phase. For example, if the interference signal is causing or expected to cause interference with the power signal transmitted from the RF wireless power transmitter 110 based on information of the interference signal, the controller 112 may change and adjust the frequency of the power signal and then transmit the same to at least one RF wireless power receiver 130. If the interference signal is still causing or expected to cause interference with the power signal despite controlling the frequency of the power signal, the controller 112 may change and adjust first the frequency and then the polarization direction and the phase of the power signal and then transmit the same to the at least one RF wireless power receiver 130.

As described above, since information of the interference signal includes information on a duty ratio, a beam sharpness, and a beam shape of the interference signal, and at least one parameter of the power signal includes a duty ratio, a beam sharpness, and a beam shape of the power signal, the controller 112 may control the at least one parameter among the duty ratio, the beam sharpness, and the beam shape of the power signal transmitted from the RF wireless power transmitter 110 to minimize interference by the interference signal based on information on the duty ratio, the beam sharpness, and the beam shape of the interference signal in operation S630.

Also, in operation S630, the controller 112 may control the at least one parameter among the frequency, the polarization direction, the phase, the duty ratio, the beam sharpness, and the beam shape of the power signal by further considering reception characteristic information of the at least one RF wireless power receiver 130 such that the power reception performance of the at least one RF wireless power receiver 130 may be ensured.

For example, the controller 112 may control the at least one parameter among the frequency, the polarization direction, the phase, the duty ratio, the beam sharpness, and the beam shape of the power signal transmitted from the RF wireless power transmitter 110 further based on information on an Rx frequency, an Rx polarization direction, an Rx phase, an Rx duty ratio, an Rx beam sharpness, and an Rx beam shape of the at least one RF wireless power receiver 130.

That is, in operation S630, the controller 112 may control at least one parameter among the frequency, the polarization direction, the phase, the duty ratio, the beam sharpness, and the beam shape of the power signal transmitted from the RF wireless power transmitter 110 by simultaneously considering an interference frequency, an interference polarization direction, an interference phase, an interference duty ratio, an interference beam sharpness, and an interference beam shape of the interference signal and the Rx frequency, the Rx polarization direction, the Rx phase, the Rx duty ratio, the Rx beam sharpness, and the Rx beam shape of at least one RF wireless power receiver 130 to minimize interference by the interference signal and, at the same time, to maximize the power reception efficiency in the at least one RF wireless power receiver 130.

Also, in operation S630, the controller 112 may dynamically adjust a power level of the power signal based on information of the interference signal and a charging state of the at least one RF wireless power receiver 130.

Also, in operation S630, the controller 112 may predict future interference that occurs due to the interference signal using an interference prediction model pretrained based on a previous interference pattern and control results and may preemptively control the at least one parameter of the power signal based on the predicted interference.

Also, in operation S630, the controller 112 may individually control the at least one parameter of the power signal according to a plurality of RF wireless power receivers based on location information and reception characteristic information of each of the plurality of RF wireless power receivers, in an environment in which the plurality of RF wireless power receivers are present.

After operation S630 is performed, the controller 112 may determine whether interference occurs in power signal transmission in the RF wireless power transmitter 110 by repeatedly performing operation S620. If it is determined that interference still occurs, the controller 112 may repeatedly perform the aforementioned operation S630. That is, the controller 112 may repeatedly perform determining whether interference occurs and controlling the parameter until interference does not occur.

The aforementioned power signal-related parameter control of the controller 112 in operation S630 may be performed before the RF wireless power transmitter 110 operates or may be performed while the RF wireless power transmitter 110 is operating.

For example, the controller 112 may perform power signal-related parameter control according to operation S630 before transmitting the power signal and then may start to transmit the parameter-controlled power signal.

As another example, the controller 112 may perform the forementioned power signal-related parameter control according to operation S630 while transmitting the power signal, thereby converting the power signal being transmitted to the parameter-controlled power signal in real time and continuing transmission.

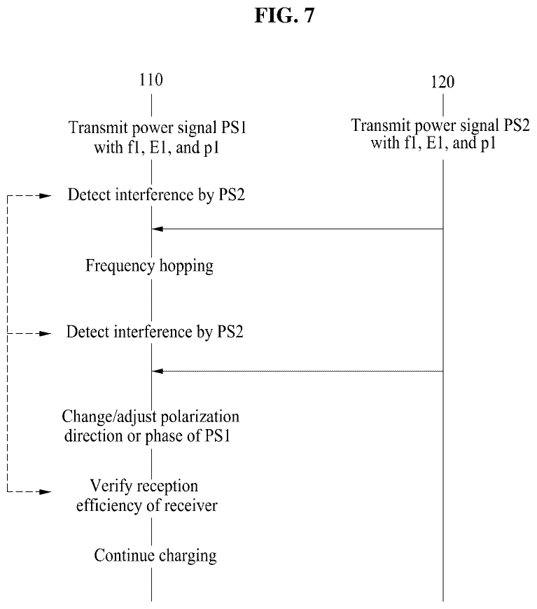

The RF wireless power transmission method in a case in which the aforementioned power signal-related parameter control of the RF wireless power transmitter 110 in operation S630 is performed during power signal transmission of the RF wireless power transmitter 110 is further described with reference to FIG. 7.

In operation S640, the transmitter may transmit the parameter-controlled power signal to at least one RF wireless power receiver.

FIG. 7 illustrates an example for describing a case in which an RF wireless power transmission method according to an example embodiment is performed during power transmission according to an example embodiment.

Initially, it is assumed that a first RF wireless power transmitter 110 and a second RF wireless power transmitter 120 is transmitting a power signal (PS1, PS2) with frequency f1, polarization direction E1, and phase p1.

Therefore, the power signal transmitted from the first RF wireless power transmitter 110 may cause interference as an interference signal with respect to the power signal transmitted from the second RF wireless power transmitter 120, and the power signal transmitted from the second RF wireless power transmitter 120 may cause interference as an interference signal with respect to the power signal transmitted from the first RF wireless power transmitter 110.

In this situation, the first RF wireless power transmitter 110 may detect the power signal of the second RF wireless power transmitter 120 as the interference signal and, based on this, may change and adjust a frequency of the power signal transmitted from the first RF wireless power transmitter 110.

If interference by the interference signal that is the power signal of the second RF wireless power transmitter 120 continues despite changing and adjusting the frequency of the power signal transmitted from the first RF wireless power transmitter 110, the first wireless power transmitter 110 may change the polarization direction or the phase of the power signal.

Here, the first RF wireless power transmitter 110 may verify the reception efficiency in the at least one RF wireless power receiver 130 resulting from a change in the polarization direction or the phase of the power signal. If the reception efficiency in the at least one RF wireless power receiver 130 is not guaranteed, the first RF wireless power transmitter 110 may change and adjust at least one parameter among the frequency, the polarization direction, and the phase of the power signal.

Although it is described that only the first RF wireless power transmitter 110 controls the frequency, the polarization direction, or the phase of the power signal, it is not limited thereto or restricted thereby and the second RF wireless power transmitter 120 may also control the frequency, the polarization direction, or the phase of the power signal using the same principle.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A wireless power transmitter included in a wireless charging system, the wireless power transmitter comprising:
a transmitter configured to transmit a power signal to at least one wireless power receiver;
a detector configured to acquire information on an interference signal from another wireless power transmitter; and
a controller configured to control at least one parameter of the power signal based on information of the interference signal.

2. The wireless power transmitter of claim 1, wherein the controller is configured to control the at least one parameter of the power signal transmitted from the wireless power transmitter to minimize interference by the interference signal that is a power signal transmitted from the other wireless power transmitter.

3. The wireless power transmitter of claim 2, wherein the controller is configured to control at least one parameter among a frequency, a polarization direction, and a phase of the power signal transmitted from the wireless power transmitter based on information on a frequency, a polarization direction, and a phase of the interference signal.

4. The wireless power transmitter of claim 3, wherein the controller is configured to control the frequency of the power signal transmitted from the wireless power transmitter to a band different from the frequency of the interference signal, to control the polarization direction of the power signal transmitted from the wireless power transmitter to a polarization direction orthogonal to the polarization direction of the interference signal, or to control the phase of the power signal transmitted from the wireless power transmitter to be orthogonal or identical to the phase of the interference signal.

5. The wireless power transmitter of claim 2, wherein the controller is configured to control at least one parameter among a duty ratio, a beam sharpness, and a beam shape of the power signal transmitted from the wireless power transmitter based on information on a duty ratio, a beam sharpness, and a beam shape of the interference signal.

6. The wireless power transmitter of claim 1, wherein the controller is configured to control the at least one parameter of the power signal further based on reception characteristic information of the at least one wireless power receiver.

7. The wireless power transmitter of claim 1, wherein the controller is configured to predict future interference that occurs due to the interference signal using an interference prediction model pretrained based on a previous interference pattern and control results and to preemptively control the at least one parameter of the power signal based on the predicted interference.

8. The wireless power transmitter of claim 1, wherein the controller is configured to individually control the at least one parameter of the power signal according to a plurality of wireless power receivers based on location information and reception characteristic information of each of the plurality of wireless power receivers, in an environment in which the plurality of wireless power receivers are present.

9. The wireless power transmitter of claim 1, wherein the controller is configured to dynamically adjust a power level of the power signal based on information of the interference signal and a charging state of the at least one wireless power receiver.

10. The wireless power transmitter of claim 1, wherein the wireless power transmitter is designed to transmit the power signal to an authenticated wireless power receiver, and configured to transmit the power signal by including encrypted authentication information in the power signal.

11. The wireless power transmitter of claim 1, wherein the wireless power transmitter includes:
a digital signal processor configured to control the at least one parameter of the power signal; and
a phase array antenna configured to be controlled by the digital signal processor.

12. A wireless power transmission method of a wireless power transmitter included in a wireless charging system, the wireless power transmission method comprising:
acquiring information on an interference signal from another wireless power transmitter;
controlling at least one parameter of the power signal based on information of the interference signal; and
transmitting the parameter-controlled power signal to at least one wireless power receiver.

13. The wireless power transmission method of claim 12, wherein the controlling comprises controlling the at least one parameter of the power signal transmitted from the wireless power transmitter to minimize interference by the interference signal that is a power signal transmitted from the other wireless power transmitter.

14. The wireless power transmission method of claim 13, wherein the controlling comprises controlling the at least one parameter among a frequency, a polarization direction, and a phase of the power signal transmitted from the wireless power transmitter based on information on a frequency, a polarization direction, and a phase of the interference signal.

15. The wireless power transmission method of claim 14, wherein the controlling comprises one of:
controlling the frequency of the power signal transmitted from the wireless power transmitter to a band different from the frequency of the interference signal;
controlling the polarization direction of the power signal transmitted from the wireless power transmitter to be orthogonal to the polarization direction of the interference signal; and
controlling the phase of the power signal transmitted from the wireless power transmitter to be orthogonal or identical to the phase of the interference signal.

16. The wireless power transmission method of claim 13, wherein the controlling comprises controlling at least one parameter among a duty ratio, a beam sharpness, and a beam shape of the power signal transmitted from the wireless power transmitter based on information on a duty ratio, a beam sharpness, and a beam shape of the interference signal.

17. The wireless power transmission method of claim 12, wherein the controlling comprises controlling the at least one parameter of the power signal further based on reception characteristic information of the at least one wireless power receiver.

18. The wireless power transmission method of claim 12, wherein the acquiring comprises one of:
receiving information of the interference signal from the other wireless power transmitter; and
receiving the interference signal from the other wireless power transmitter and then analyzing the interference signal and extracting the information of the interference signal.
